(19) United States
(12) Patent Application Publication
(10) Pub. No.: US 2009/0044664 A1
(43) Pub. Date: Feb. 19, 2009

(54) STAKE DRIVER WITH ADJUSTABLE INSERTS

(76) Inventors: Lee Marvin Geisler, Santa Barbara, CA (US); Jeffrey Scott Aubrey, Santa Barbara, CA (US)

Correspondence Address: LOZA & LOZA LLP, 305 N. Second Avenue, #127, Upland, CA, 91786-6064, US

(21) Appl. No.: 11/838,864

(22) Filed: Aug. 14, 2007

(51) Int. Cl. B25C 3/00

(52) U.S. Cl. 81/44; 81/487

(57) ABSTRACT

A stake driver is provided including a longitudinal shaft having a strike portion at a first end and a receiving socket at a second end of the shaft. The socket defining a first cavity to receive a stake. A handle may be coupled to the shaft and positioned concentric with the shaft. A protective flange is positioned coplanar with the strike portion of the shaft and shaped to protect a user's hand when holding the handle. The first cavity may be shaped and sized to fit snuggly around a strike end of the stake. The receiving socket distributes a strike force evenly across a striking end of the stake, thus inhibiting splintering of the stake. An adaptor may also be included to fit within the first cavity. The adaptor defining a second cavity sized to receive a stake of different size than the stake received by the first cavity.

### FIELD

Various embodiments of the invention pertain to stake drivers. At least one embodiment of the invention pertains to a handheld stake driver that has a wide upper end and an adjustable receiving socket to enable the user to drive a stake more easily and safely.

### BACKGROUND

A stake is typically a wooden pointed object that is thrust into the ground to serve as an anchor or marker. For example, stakes are often used in constructions to secure footing forms and surveying projects to demarcate boundaries or reference points. When a stake is driven into the ground or other surface, oftentimes, the stake will break or splinter due to the impact with the hammer and/or the ground if the hammering is done at an improper angle. Also, hammers often slip upon impacting the stake which can result in injury to the user holding the stake.

Existing tools that assist in driving stakes into the ground do not provide for proper protection of the user's hand. The gripping area in existing tools is rather narrow or non-existent making it difficult to properly drive in the stake without injury to the user.

Also, in prior art drivers, the socket in which the tool receives the stake does not provide for different sizes and shapes of stakes. Accordingly, if the driver socket is improperly sized this increases the possibility of damaging the stake or injuring the user's hand.

Consequently, a handheld stake driver is needed that protects a user from hand injury while accommodating stakes of different sizes.

### SUMMARY OF THE INVENTION

A stake driver is provided comprising a longitudinal shaft having a strike portion at a first end. A receiving socket is coupled to a second end of the shaft, the socket defining a first cavity sized to receive a stake. A handle may be coupled to the shaft and positioned concentric with the shaft. A protective flange positioned coplanar with the strike portion of the shaft and shaped to protect a user's hand when holding the handle. The protective flange and handle are coupled to each other. The handle may also have finger grooves whereby a user can grip the stake driver.

The first cavity in the receiving socket may be shaped and sized to fit snuggly around a strike end of the stake, shaft and receiving socket configured to transfer a striking force from the strike portion to the stake in the receiving socket, wherein the receiving socket distributes the strike force evenly across a striking end of the stake. The first cavity may thus inhibit splintering of the striking end of the stake.

The stake driver may also include an adaptor configured to fit within the first cavity. The adaptor defining a second cavity sized to receive a stake of different size than the stake received by the first cavity. The adaptor is secured to the receiving socket by one or more fasteners. A plurality of interchangeable adaptors may be configured to fit within the first cavity, each of the plurality of adaptors having a cavity sized and shaped to receive stake of different size than other adaptors.

A stake driver apparatus is also provided comprising: (a) a longitudinal shaft having a strike portion at a first end, (b) a receiving socket coupled to a second end of the shaft, the socket defining a first cavity sized to receive a stake, and (c) an adaptor configured to fit within the first cavity, the adaptor defining a second cavity sized to receive a stake of different size than the stake received by the first cavity, wherein the first cavity in the receiving socket and the adaptor are shaped and sized to fit snuggly around a strike end of the stake. The shaft and receiving socket may be configured to transfer a striking force from the strike portion to the stake in the receiving socket, wherein the receiving socket and adaptor distribute the strike force evenly across a striking end of the stake. The first cavity in the receiving socket inhibits splintering of the striking end of the stake.

The stake driver may also include a protective flange positioned coplanar with the strike portion of the shaft and shaped to protect a user's hand when holding the shaft, and a handle coupled to the shaft and concentric with the shaft, wherein the handle has finger grooves whereby a user can grip the stake driver. The shaft and receiving socket are made of metal and the adaptor is made of plastic.

### BRIEF DESCRIPTION OF THE DRAWINGS

FIG. 1 illustrates a side view of a stake driver according to one example.

FIG. 2 illustrates a bottom view the stake driver.

FIG. 3 illustrates a top view of the of the stake driver.

FIGS. 4, 5, and 6 illustrate how the stake driver may be used to drive a stake into the ground or other surface.

FIGS. 7, 8, and 9 illustrate how interchangeable adaptors may be inserted into the stake driver socket to allow using different size stakes.

FIGS. 10 and 11 illustrate various mechanisms for securing adaptors to the receiving socket of a stake driver.

### DETAILED DESCRIPTION

In the following description numerous specific details are set forth in order to provide a thorough understanding of the invention. However, one skilled in the art would recognize that the invention might be practiced without these specific details. In other instances, well known methods, procedures, and/or components have not been described in detail so as not to unnecessarily obscure aspects of the invention.

In the following description, certain terminology is used to describe certain features of one or more embodiments of the invention. For instance, the term “stake” refers to a pointed piece of wood, plastic, and/or metal to be driven into the ground as a marker or support.

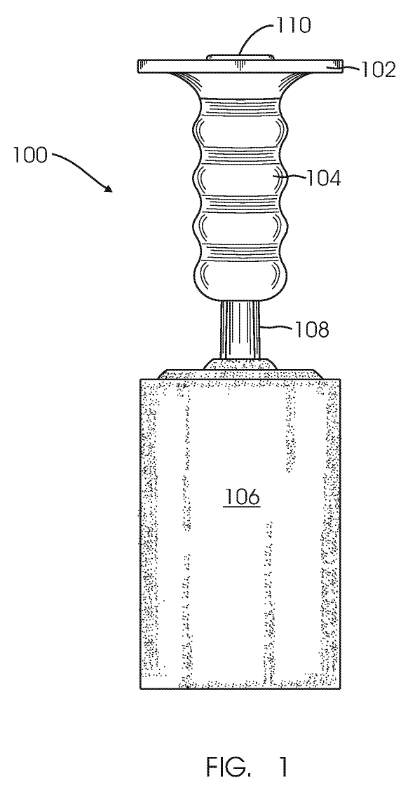

FIG. 1 illustrates a side view of a stake driver 100 according to one example. The stake driver 100 includes a protective flange 102 and a handle 104 at a first of a shaft 108 and a receiving socket 106 at a second end of the shaft 108. The shaft 108 may include a strike portion 110 and extends through the handle 104 and protective flange 102. The strike portion 110 may be sufficiently large to strike with a hammer or mallet. The shaft 108 may be made of a strong, durable, impact resistant material that can withstand the striking force of a hammer or mallet. The handle 104 may be made of plastic or rubber such that it allows the user to have a good grip on the stake driver 100. The protective flange 102 may be integral with the handle 104 or a separate member made of a sturdy material capable of deflecting a hammer strike to protect a user's hand. The handle 104 may be molded or include grip grooves that facilitate gripping by a user while the stake driver 100 is being driven into the stake.

In one embodiment, the receiving socket 106 may be made of hard metal or other durable material. The material used for the receiving socket 106 may be resistant to heavy impact of a hammer or mallet when a stake is driven into the ground. In one example, the receiving socket 106 may include a metal first portion closest to the shaft 108 with a plastic second portion defining the remainder of the socket. Limiting the size of the metal portion of the socket 106 may result in lowering the cost and/or weight of the stake driver 100.

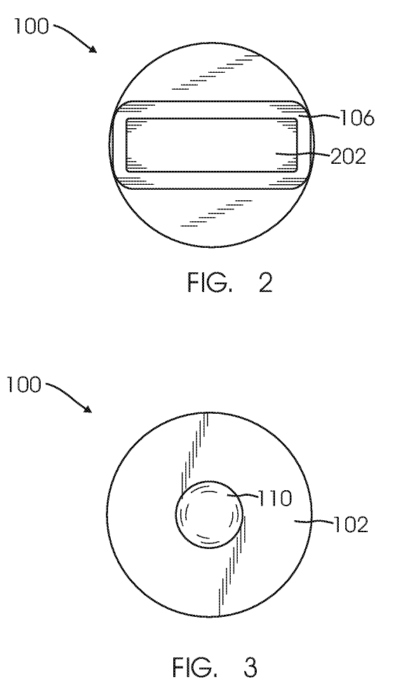

FIG. 2 illustrates a bottom view the stake driver 100. This view illustrates a cavity 202 defined by the receiving socket 106 of the stake driver 100. The cavity 202 may be sized and/or shaped to provide a tight or snug fit around the striking end of a stake. The snug fit created by the receiving socket 106 around the striking end of the stake evenly distributes the striking force across the whole end of the stake. Where as striking the end of a stake directly with a hammer or mallet may cause it to splinter, the receiving socket 106 evenly distributes the force across the end of the stake while keeping the stake from splintering. This decreases the likelihood of damaging or breaking the stake while it is being pounded into the ground. The stake driver 100 also makes it easier to drive the stake into the ground by providing a single, well-defined strike portion 110.

The receiving socket 106 cavity 202 may be configured to accept various attachments that facilitate using stakes of different sizes and shapes. Additionally, the stake driver 100 may also couple to power tools that can drive a stake into the ground. Thus, the stake driver 100 may not only be used manually but also with an electric power tool.

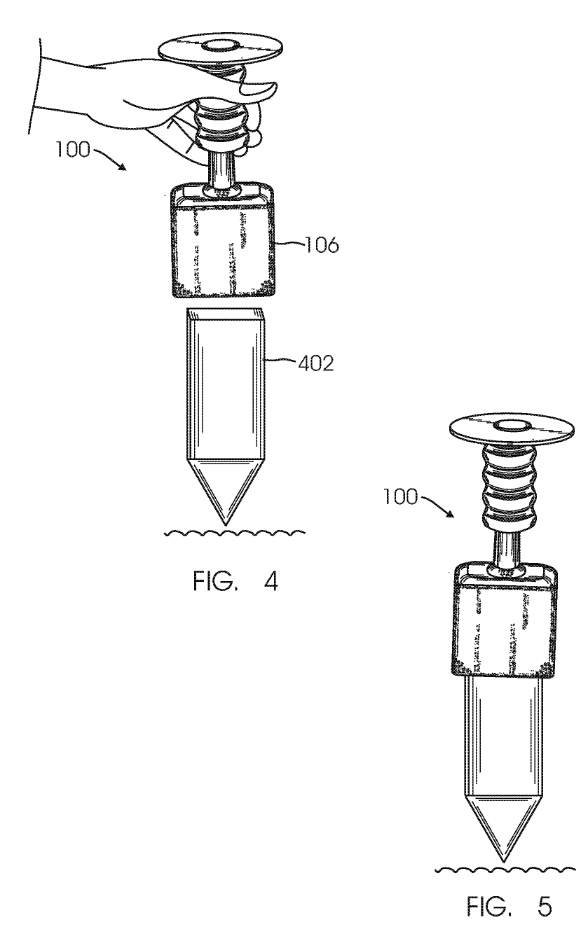

FIG. 3 illustrates a top view of the of the stake driver 100. The protective flange 102 and strike portion 110 of the shaft 108 are shown. The strike portion 110 may have a diameter that is at least wide enough to accommodate hammers and/or mallets of many shapes and sizes. The strike portion 110 is impacted with a hammer and/or mallet when the receiving socket 106 is disposed upon a stake. The strike portion 110 provides a sufficiently large surface area that the hammer and/or mallet should not slip when it strikes the strike portion 110. Even if the hammer or mallet misses the strike portion 110, the protective flange 10 This is a safety feature that prevents fingers, hands, arms etc. from being injured when a stake is being driven into the ground or other surface.

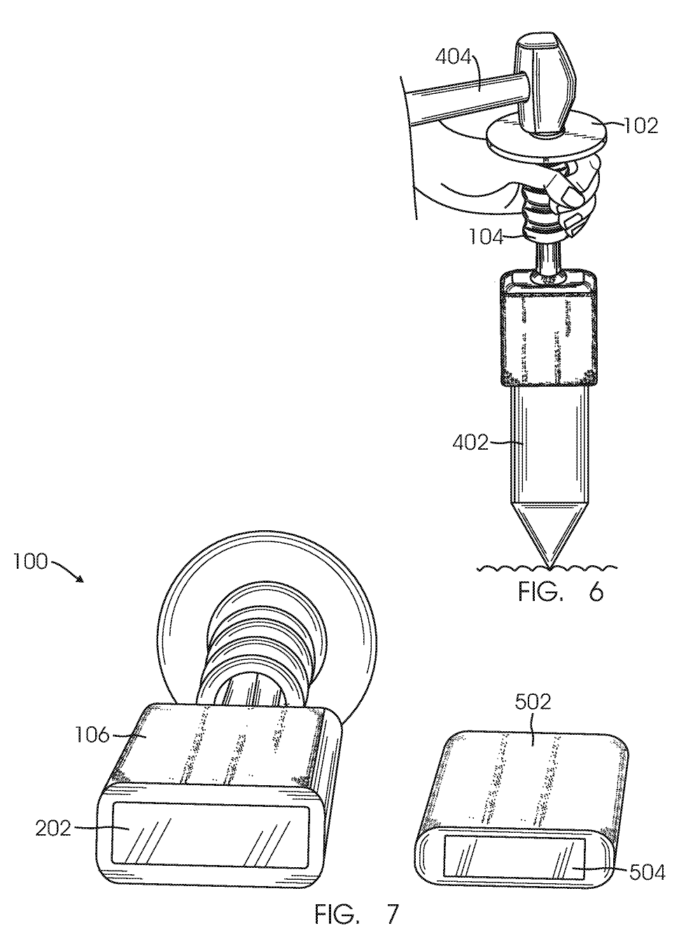

FIGS. 4, 5, and 6 illustrate how the stake driver 100 may be used to drive a stake into the ground or other surface. The stake driver 100 may be used with various kinds or types of stakes made of one or more materials, such as wood, metal, plastic, etc. FIG. 4 illustrates the stake driver 100 as the receiving socket 106 is being placed into the top of a stake 402. FIG. 5 illustrates the receiving socket 106 inserted on top of the stake 402. FIG. 6 illustrates how a user may grasp the handle 104 and impact the strike portion 110 with a mallet 404 so that the stake 402 is driven into the ground by the force that passes from the strike portion 110, to the receiving socket 106 and then to the stake 402. As the strike portion 110 is struck several times, the force of the impact drives the stake 402 into the ground or other surface.

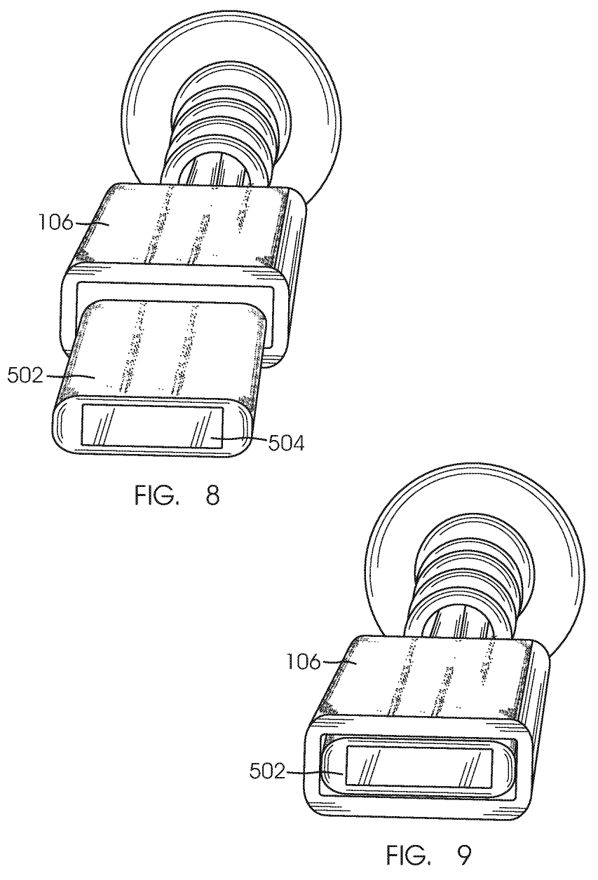

FIGS. 7, 8, and 9 illustrate how interchangeable adaptors 502 may be inserted into the stake driver socket 106 to allow using different size stakes. The external size of the adaptor 502 may be defined so that it fits snuggly within the cavity 202 of the receiving socket 106. Meanwhile, a receiving cavity 504 is defined within the adaptor 502; such cavity 504 being sized and/or shaped to provide a snuggly fit for a particular type or size of stake. Although the adaptor 502 shown is rectangular in shape, different adaptor sizes and shapes may be used to accommodate various types of stakes. For example, the receiving cavity 504 may be square or circular in shape. In various examples, the cavity 504 may extend completely or partially through the length of the adaptor 504.

In alternative implementations, the receiving socket 106 may have a circular or square shape. Consequently, the socket cavity 202 may be circular or square as well, thereby allowing the use of adaptors having a circular or square internal or external shape.

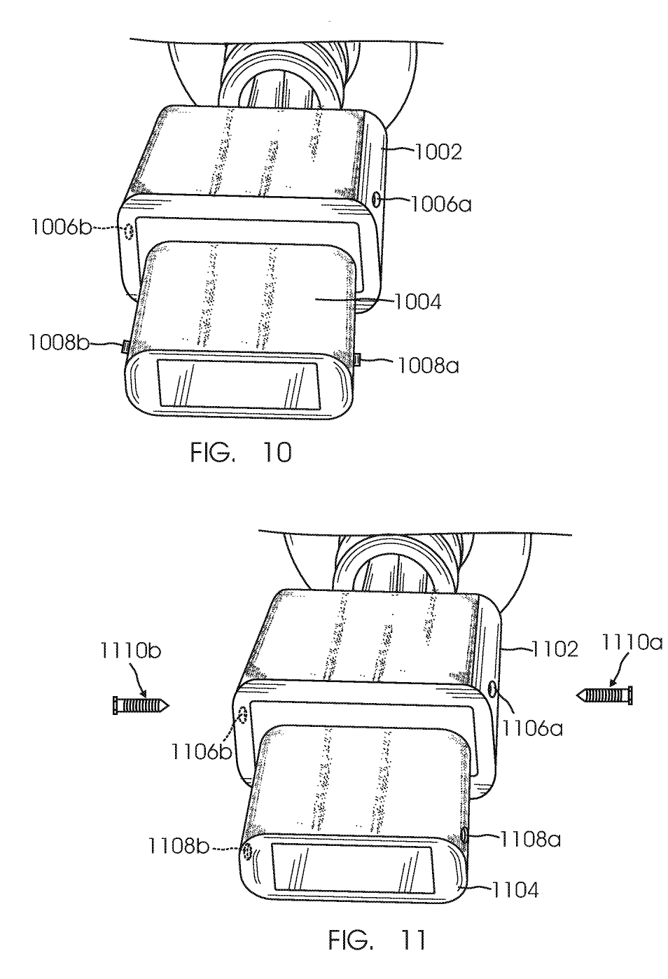

In some implementations, the adaptor 502 can be attached to the stake driver 100 by various fastening devices, such as screws, magnets, Velcro, and/or spring loaded buttons, that keep the adaptor 502 securely coupled to the receiving socket 106 when driving a stake into the ground. For example, FIG. 10 illustrates a receiving socket 1002 having openings 1006 to engage corresponding spring loaded push buttons 1008 in an adaptor 1004. If the adaptor 1004 needs to be replaced or removed, the buttons 1008 can be depressed so that the adaptor 1004 is released from the receiving socket 1002. In another example, FIG. 11 illustrates a receiving socket 1102 having one or more holes 1106 that accept one or more screws 1110 to lock the adaptor 1104 into place by engaging into one or more corresponding cavities 1108 in the adaptor 1104.

One or more of the components and functions illustrated in FIGS. 1, 2, 3, 4, 5, 6, 7, 8, 9, 10 and/or 11 may be rearranged and/or combined into a single component or embodied in several components without departing from the invention. Additional elements or components may also be added without departing from the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled, in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is

1. A stake driver comprising:
a longitudinal shaft having a strike portion at a first end;
a receiving socket coupled to a second end of the shaft, the socket defining a first cavity sized to receive a stake;
a handle coupled to the shaft and concentric with the shaft; and
a protective flange positioned coplanar with the strike portion of the shaft and shaped to protect a user's hand when holding the handle.

2. The stake driver of claim 1, wherein the first cavity in the receiving socket is shaped and sized to fit snuggly around a strike end of the stake, shaft and receiving socket configured to transfer a striking force from the strike portion to the stake in the receiving socket, wherein the receiving socket distributes the strike force evenly across a striking end of the stake.

3. The stake driver of claim 2, wherein the first cavity in the receiving socket inhibits splintering of the striking end of the stake.

4. The stake driver of claim 1, wherein the protective flange and handle are coupled to each other.

5. The stake driver of claim 1, wherein the handle has finger grooves whereby a user can grip the driver.

6. The stake driver of claim 1, wherein the shaft and receiving socket are made of metal.

7. The stake driver of claim 1, further comprising:
a removable adaptor configured to fit within the first cavity, the adaptor defining a second cavity sized to receive a stake of different size than the stake received by the first cavity.

8. The stake driver of claim 7, wherein the adaptor is secured to the receiving socket.

9. The stake driver of claim 1, further comprising:
a plurality of interchangeable adaptors configured to fit within the first cavity, each of the plurality of adaptors having a cavity sized and shaped to receive stake of different size than other adaptors.

10. A stake driver apparatus comprising:
a longitudinal shaft having a strike portion at a first end;
a receiving socket coupled to a second end of the shaft, the socket defining a first cavity sized to receive a stake; and
an adaptor configured to fit within the first cavity, the adaptor defining a second cavity sized to receive a stake of different size than the stake received by the first cavity, wherein the first cavity in the receiving socket and the adaptor are shaped and sized to fit snuggly around a strike end of the stake, the shaft and receiving socket configured to transfer a striking force from the strike portion to the stake in the receiving socket, wherein the receiving socket and adaptor distribute the strike force evenly across a striking end of the stake.

11. The stake driver of claim 10, wherein the first cavity in the receiving socket inhibits splintering of the striking end of the stake.

12. The stake driver of claim 10, further comprising:
a protective flange positioned coplanar with the strike portion of the shaft and shaped to protect a user's hand when holding the shaft.

13. The stake driver of claim 10, further comprising:
a handle coupled to the shaft and concentric with the shaft; wherein the handle has finger grooves whereby a user can grip the stake driver.

14. The stake driver of claim 10, wherein the shaft and receiving socket are made of metal and the adaptor is made of plastic.

15. The stake driver of claim 10, further comprising:
a plurality of other interchangeable adaptors configured to fit within the first cavity, each of the plurality of adaptors having a cavity sized and shaped to receive stake of different size than other adaptors.

16. The stake driver of claim 10, further comprising:
one or more spring loaded buttons coupled to the adaptor that engage corresponding members in the first cavity to secure the adaptor to the receiving socket.

17. The stake driver of claim 10, further comprising:
one or more fasteners for securing the adaptor to the receiving socket.
